(19) United States
(12) Patent Application Publication
(10) Pub. No.: US 2008/0143191 A1
(43) Pub. Date: Jun. 19, 2008

(54) ELECTRONIC TIMER MODULE FOR BATHROOM FANS

(76) Inventor: Vadim Laser, (US)

Correspondence Address: VADIM LASER, 8255 SPINNAKER LANE, MAINEVILLE, OH, 45039-9540, US

(21) Appl. No.: 11/612,719

(22) Filed: Dec. 19, 2006

(51) Int. Cl. H01H 7/00; G08B 21/00

(52) U.S. Cl. 307/141; 340/660

(57) ABSTRACT

Electronic Timer Module securely encapsulated in a plastic shell with three wires protruding from the shell for easy connecting to a standard ON/OFF switch and accommodating inside of a common outlet box automatically shuts off power to the bathroom exhaust fan after a fixed time interval and can be instantly restarted or turned off.

### BACKGROUND OF THE INVENTION

This invention is concerned with improvement of functionality of wall mounted switches that control power to exhaust fans in private and public bathrooms. Exhaust fans in the bathrooms need to be activated for a limited period. However, a typical application of the ON/OFF switch requires a user to return to the bathroom in 15 to 30 minutes simply for turning the switch off. Frequently it causes inconvenience because people may need to leave the premises shortly after use of the bathroom, or they forget to return, or for elderly and disable people an extra trip to the bathroom may present a significant and unwelcome challenge. Fans may operate unnecessary long. This reduces their MTBF (life time between failures), causes waist of electric energy consumed by the fans and thermal energy of the heated or conditioned air wastefully thrown into the atmosphere and creates possibly irritating noise. All these little problems can be fixed, which contributes to improving comfort of living. There are timers sold at the hardware and home improvement stores that can be installed instead of the existing ON/OFF switches. Typically, these timers are based on a mechanically winded spring motor. They are noisy, relatively expensive and alter appearance of the switch faceplate. There are some electronic timers available, but they also have drawbacks such as high cost, necessity to change the faceplate appearance, which may be aesthetically objectionable, unneeded complication of use with multiple pushbuttons and LED indicators that require training and may be confusing to some users.

The U.S. Pat. No. 6,121,889 to Janda, et al. describes an in-wall mounted electronic timer. It is a silent device, but suffers from unneeded complexity of construction and operation. For many users a necessity of learning how to operate a multi-button interface panel just to use a bathroom fan would appear unacceptable if not ridiculous. A busy appearance and increased cost, resulted from incorporation of the display, special housing and multiple keys add to the problem.

The U.S. Pat. No. 7,026,729 to Homan, et al. discloses a solution that makes operation of the exhaust fan dependent on the control of the illuminating light. When a bathroom window provides sufficient amount of light there is no need to turn on an electric light. In such a case an exhaust fan would not operate.

The U.S. Pat. No. 4,912,376 to Strick discloses a timed actuator for conventional wall switch. The Strick invention comprises a battery-powered appliance affixed to an existing toggle-style wall switch wherein a timer, control circuitry, and an electrical motor are powered. The Strick invention employs a switch lever engaging mechanism which is powered by the motor upon command from the timer and control circuitry thereby providing a timed on and off cycle. This solution is cumbersome, expensive and technologically outdated.

In the U.S. Pat. No. 5,051,607 to Dalton a switch time delay apparatus is disclosed wherein an electronic time delay circuit is connected in parallel with a single pole switch connected to an alternating current source and load. The Dalton invention employs a voltage comparator, two timers, an opto-isolator, and a triac switch. A combination of the aforementioned electronic components circuitry detects the duration of an on-off toggle of the single pole switch. If the single pole switch is toggled slowly the circuitry provides simple on and off functions as would be experienced by the single pole switch alone. However, if the single pole switch is toggled rapidly terminating in the off position a timer provides a latching signal to the triac gate and the load receives power through the conducting triac. The need for special learning and training of how fast to manipulate the wall mounted switch in order to obtain a desired time delay makes this invention not practical.

In U.S. Pat. No. 4,494,012 to Coker a switch timer is described wherein an electronic circuit is interconnected with manual switch in line with a load, thereby providing a selectable on state, off state, or delayed turn off state. The Coker solution requires installation of a three-position switch, which is often an undesirable complication.

The U.S. Pat. No. 4,002,925 to Monahan describes a wall mounted contraption that has at least three-position switch and requires generation of a short pulse to initiate the timer. This solution suffers from unneeded complication of use.

In the U.S. Pat. No. 4,766,331 to Flegel et al. a timer switch with auxiliary actuator is disclosed for controlling the supply of electricity to an electrical load. An auxiliary actuator comprising solenoid is provided to act independently of the timer switch, thereby permitting powering the load in response to both timer function and the presence or absence of an outside stimulus provided by sensor in response to conditions such as the appearance of light or particular levels of relative humidity. This prior art lacks the desired simplicity.

The U.S. Pat. No. 4,500,795 to Hochstein et al. discloses an electrical timing control switch delaying the turnoff of a load for a predetermined period. The disclosure teaches a timer controlled triac solid-state switch based circuit to conduct line power to the load. The timer is actuated by a momentarily type pushbutton and following a predetermined delay the load is momentarily switched off and on at least once to indicate an impending time out and final load turn off. The necessity of changing a regular two position switch to a pushbutton type momentarily switch is a disadvantage of this invention for use to control a bathroom exhaust fan. In addition, generation of a series of short duration on/off conditions prior to expiration of the delay is not compatible with the exhaust fan application.

What needed is a compact, inexpensive, silent, simple and intuitively operable without any instructions or training timing module, easily installable by an average homeowner behind an existing on/off switch.

### SUMMARY OF THE INVENTION

The proposed invention offers solution for a desirable timing module. The module is an electronic device that has no moving parts and no electromechanical relays, no pushbuttons or other contact-based components prone to failure. The electronic module is a small, durable printed circuit board that carries electronic components. Said printed circuit board with the components mounted on it is encapsulated into a durable plastic compound. Three colored wires emanate from the module for connecting the module to the electrical wiring. The proposed timing module can be connected to the existing on/off switch that controls power to the exhaust fan. The module is so compact that it can be readily installed behind the existing on/off switch inside the outlet box. The encapsulating plastic shell provides excellent electrical isolation of the electronic components, seals them from humidity and provides mechanical protection. The timing module consumes negligible power, does not alter appearance of the existing switch faceplate and offers simple and intuitive functionality. The timer starts at the moment the switch is turned on and runs for a fixed period, typically 15 to 30 minutes depending on a factory setting. At any time the exhaust fan can be turned off, if so desired. At any moment, the timer can be restarted by simply turning the switch off and on again.

### BRIEF DESCRIPTION OF THE DRAWINGS

FIG. 1 shows the timer module encapsulated in a plastic shell.

FIG. 2 is a block diagram of the electronic timer module.

FIG. 3 is a wiring diagram illustrating simplicity of timer module installation.

FIG. 4 is a block diagram of the electronic timer module with inclusion of the visible LED for assistance during installation.

FIG. 5 is a drawing of a timer module with the visible LED incorporated.

### DETAILED DESCRIPTION OF THE PREFERRED EMBODIMENT

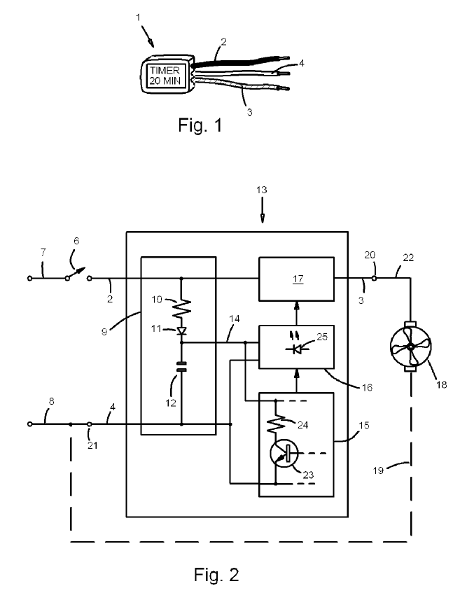

The timer module 1, shown in the FIG. 1, in appearance reminds a small plastic pebble typically of size 35 mm by 25 mm by 10 mm. A good material for encapsulation is thermoplastic polyamid material OM657 manufactured by Henkel. It has flammability rating UL 94 V-0 and dielectric strength 15 kV/mm. Three insulated wires emanate from the side of the module. The insulation of each wire has a meaningful color. The wire 2 is black, wire 4 is white and wire 3 is typically blue or other color except white and black. The tag on the side of the module indicates the value of delay time that the module provides. The FIG. 2 shows a block diagram of the timer module, and the way it connects to the power lines and the exhaust fan. A typical application for the timer module is expected to be a retrofit of the existing wall-mounted on/off switch. Presumably, the on/off switch 6 is mounted inside an outlet box and is connected to the hot wire 7 of the in-wall wiring. The other contact of the switch 6 shall be connected with the black wire 2 of the timer module. The rectangle 13 outlines the main blocks of the electronics of the timer module. The white wire 4 of the timer module shall be connected to the common wire 8 of the in-wall wiring at the point 21, typically with a wire nut. The blue wire 3 of the timer module shall be connected with another wire nut at the point 20 with the wire 22 that delivers power to the exhaust fan 18. The return wire 19 from the fan 18 may be hidden inside the walls and connected to the common wire 8 inside or outside the wiring box. The entire timer module comprises four main blocks. The block 17 is an electronic relay or a triac, which can be turned on and off by the opto-coupler block 16. A preferred opto-coupler for this application has the LED 25 that requires a small operating current of 5 mA typically. The input of the opto-coupler 16 connects to the output of the timing block 15. The timing block 15 is a CMOS (complemented pair metal-oxide semiconductor) integrated circuit that requires a very little current to operate, which is typically much less than 1 mA. A low level DC (direct current) voltage needed for operation of the blocks 16 and 15. It is provided by the simple power supply circuit 9. The resistor 10 limits the current available to these circuits. The power dissipated by this resistor is low and typically less than 500 mW. The diode 11 rectifies the current, which accumulates on the capacitor 12, providing a filtered DC voltage to the blocks 15 and 16. A low voltage zener diode, not shown here on FIG. 2, may be optionally connected in parallel to the capacitor 12 for reducing the voltage ripple. The time counting block 15 is either a low cost microcontroller or a hardware oscillator with a multistage pulse counter. In either case, the timer block 15 immediately upon appearance of the power voltage on the conductor 14 turns on the current to the LED 25 of the opto-coupler 16 and begins counting time. The opto-coupler turns on the triac 17, which in turn delivers power to the exhaust fan 18. As long as the timing circuit 15 counts time, the exhaust fan continues to operate. During this period, typically about 20 minutes, the transistor 23 is turned off. As soon as the timing circuit 15 reaches the predetermined limit of typically 20 minutes, it terminates current to the LED 25 of the opto-coupler 16 and turns the transistor 23 on. The resistor 24 presents about the same load to the power supply circuit 9 as the circuit of LED 25, such that the current trough the conductor 14 does not change significantly, but is simply diverted from the LED 25 to the resistor 24. At the same moment the opto-coupler 16 turns off the triac 17, which disconnects power from the exhaust fan 18. The main switch 6 may continue being in the on state for indefinite time, but the exhaust fan terminates its operation after a fixed interval, typically of 20 minutes. The switch 6 can be turned off at any moment either to stop the fan when it is running, or after the fan stops simply to return the switch into a default off position. If a resumption of the fan operation is desired, the switch 6 can be turned on at any time. The presence of the transistor 23 and resistor 24 assures a very fast initialization of the timing block. Without this circuit the capacitor 12 would not be able to discharge quickly enough after the switch 6 is turned off, thus causing inconvenience of waiting for restarting the exhaust fan. Besides, the voltage on the capacitor would begin to rise due to the significantly diminished discharge current, and presence of the zener diode would be a necessity.

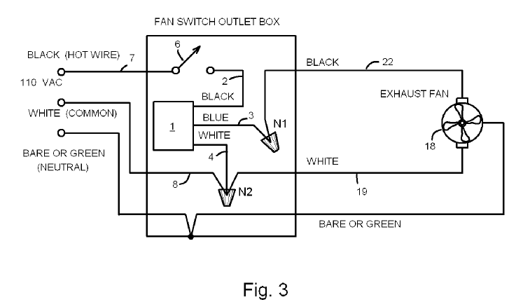

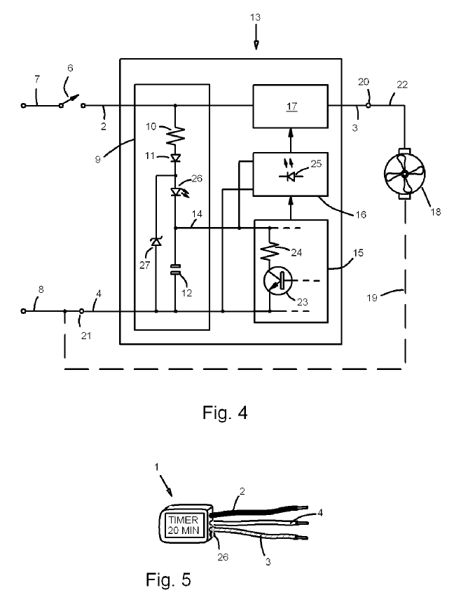

FIG. 4 shows an addition to the main circuit depicted in FIG. 3 of a low current visible LED 26 and a zener diode 27. The role of the zener diode was discussed above, but usefulness of the LED 26 can be appreciated by those home improvement enthusiasts who do not have proper equipment for detecting live 110 volts AC voltage. During installation of the timer module into an existing on/off wall-mounted switch outlet box it is necessary to identify which out of the two wires 7 and 22 connected to the switch is hot. Usually both these wires have the same black color insulation. Presence of the LED 26 helps to do it easily. The white wire 4 can be connected first to the white wire 8 of the existing wiring. Then with the black wire 2 of the timer module each of the wires coming to the switch, placed in the off position, can be briefly probed by touching them one at a time. When the hot wire 7 is touched the LED 26 will lit, indicating presence of the 110 VAC. The wire 22 then shall be disconnected from the switch and replaced with the black wire 2 of the timer module. FIG. 5 shows the lens of the LED 26 protruding through the plastic shell of the timer module so the light from this LED is visible to the installer during probing of the hot wire.

The FIG. 3 depicts a wiring diagram and illustrates simplicity of installation of the timer module into an outlet box of the existing wall switch. Detection of the hot wire can be performed as discussed above. The wire 22, coming from the fan, is disconnected from the on/off switch 6 and connected with a wiring nut N1 to the blue wire 3 of the timer module 1. The black wire 2 of the timer module replaces the wire 22 on the on/off switch 6. The white wire 4 of the timer module connects to the common wires 8 and 19 with the wire nut N2. If the common white wire 8 is not available in the outlet box, the wire 4 can be connected to the neutral wire because the current consumed by the timer module itself is typically in order of 3 mA, which is negligible. The small dimensions and durability of plastic encapsulation of the electronic components makes installation of the timer module in the space behind the on/of switch possible and easy. The operation of the on/off switch with the timer module installed is intuitive and does not require any training or learning. Appearance of the switch and its faceplate is not altered. The cost of the device is minimal, yet the timer module is safe and dependable.

What is claimed is:

1. An electronic timer module comprising a triac, an opto-coupler integrated circuit, a CMOS time counter, a voltage rectifier circuit equipped with a quick discharge circuit activated by said CMOS time counter.

2. The electronic timer module per claim 1, having the CMOS timer counter implemented as a microcontroller, which is programmed to begin count time immediately upon appearance of power supply voltage.

3. The electronic timer module per claim 1, having the CMOS timer counter implemented as combination of pulse oscillator and pulse counter, which is configured to begin count time immediately upon appearance of power supply voltage.

4. An electronic timer module comprising following components: a triac, an opto-coupler integrated circuit, a CMOS time counter, a voltage rectifier circuit equipped with a quick discharge circuit activated by said CMOS time counter, all said components mounted on a printed circuit board and molded over with an insulating plastic shell with three wires protruding through the shell for external connection.

5. The electronic timer module per claim 4, where the insulating plastic shell is thermoplastic polyamid material.

6. The electronic timer module per claim 4, where dimensions of the encapsulated electronic assembly do not exceed 35 mm×25 mm×10 mm.

7. The electronic timer module per claim 4, where the three wires emanating from the module are color coded as black for connecting to the switch, white for connecting to the common and remaining color wire for connecting to the load.

8. The electronic timer module per claim 7, when used connected with a bathroom exhaust fan as a load.

9. An electronic timer module comprising following components: a triac, an opto-coupler integrated circuit, a CMOS time counter, a voltage rectifier circuit incorporating a visible LED and said rectifier circuit equipped with a quick discharge circuit activated by said CMOS time counter, all said components mounted on a printed circuit board and molded over with an insulating plastic shell such that the lens of said LED protrudes through the said plastic shell and three wires protrude through the shell for external connection.

10. Method of detecting a hot wire of the two wires connected to the wall mounted switch during installation of the exhaust fan timer into an existing wall outlet box with the use of a visible LED built into the timer module, by connecting the white wire of said module to the common or neutral wire present in the outlet box and probing with the black wire of the timer module each of the two wires connected to the said switch.
